(19) United States
(12) Patent Application Publication
(10) Pub. No.: US 2025/0292544 A1
(43) Pub. Date: Sep. 18, 2025

(54) Car Health Scan Data for Improved Risk Assessment

(71) Applicant: Sure, Inc., Dallas, TX (US)

(72) Inventor: Wayne Slavin, Santa Monica, CA (US)

(21) Appl. No.: 19/079,271

(22) Filed: Mar. 13, 2025

Related U.S. Application Data
(60) Provisional application No. 63/564,825, filed on Mar. 13, 2024.

(51) Int. Cl. G06V 10/764; G06Q 30/0601

(52) U.S. Cl. CPC G06V 10/764; G06Q 30/0627; G06Q 30/0631; G06V 2201/08

(57) ABSTRACT

A vehicle-related product recommendation is determined using artificial intelligence. A user requests a product for a vehicle, where the product is characterized by parameters (e.g., a tire is characterized by a load index, an insurance policy is characterized by a deductible, etc.). Images of the vehicle are captured for analysis using artificial intelligence to identify portions of the vehicle relevant for determining product parameters. Vehicle health metrics are determined for the identified portions of the vehicle and the product parameters are calculated using the vehicle health metrics. A product parameter of the calculated product parameters is provided to the user for acceptance.

### CROSS-REFERENCE TO RELATED APPLICATIONS

This application claims the benefit of U.S. Provisional Application No. 63/564,825 filed Mar. 13, 2024, which is incorporated by reference herein.

### BACKGROUND

### 1. Technical Field

The subject matter described relates generally to vehicles and, in particular, to using artificial intelligence to evaluate the health of a vehicle and provide corresponding product recommendations.

### 2. Background Information

Understanding the condition of a vehicle is valuable in many contexts. When buying, selling, leasing, insuring, or providing other services relating to a vehicle, many companies employ appraisers to evaluate the health of a vehicle and provide a report on their findings. These findings can then we used to evaluate how to proceed with the vehicle. However, such appraisals are subjective, time consuming, and prone to errors. Thus, service providers often misunderstand the risk associated with the vehicle and may make poor choices, leading to inefficiencies.

### SUMMARY

The above and other problems can be addressed by using an artificial intelligence (AI) car scanning process that produces one or more vehicle health metrics. The vehicle health metrics may be used to recommend or set parameters for products associated with the vehicle. For example, the vehicle health metrics may be provided as input to a model that outputs a premium rate for insuring the vehicle.

In one embodiment, a process for providing a product relating to a vehicle includes obtaining images of the vehicle, such as a video of the vehicle recorded using a smartphone. One or more information items are obtained from the images and used to calculate parameters of the product (such as a cost/premium, deductible, maximum coverage amount, exclusions for existing damage, etc.). The information items can include identifying information for the vehicle (e.g., Vehicle Identification Number (VIN), year, make, or trim level, etc.) as well an information about the health of the vehicle (e.g., mileage, tire wear, brake pad wear, presence of rust, chips or cracks in windshield, or chips or scratches in paint, etc.) Some of the parameters may be derived directly from analysis of the images while others may be obtained from a database (e.g., using a VIN identified from the images) or an on-board computer of the vehicle. A product parameter of a product is provided to a user associated with the vehicle (e.g., the vehicle's owner). On receiving acceptance of the product parameter from the user, the product is provided having the calculated parameters.

### BRIEF DESCRIPTION OF THE DRAWINGS

FIG. 1 is a block diagram of a networked computing environment suitable for providing vehicle-related products using vehicle health metrics, according to one embodiment.

FIG. 2 is a block diagram of the vehicle scanner of FIG. 1, according to one embodiment.

FIG. 3 is a block diagram of the product server of FIG. 1, according to one embodiment.

FIGS. 4A-4D depict graphical user interfaces for providing vehicle-related products, according to one embodiment.

FIG. 5 is a flowchart of a method for providing a vehicle-related product based on vehicle health metrics, according to one embodiment.

FIG. 6 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Example Systems

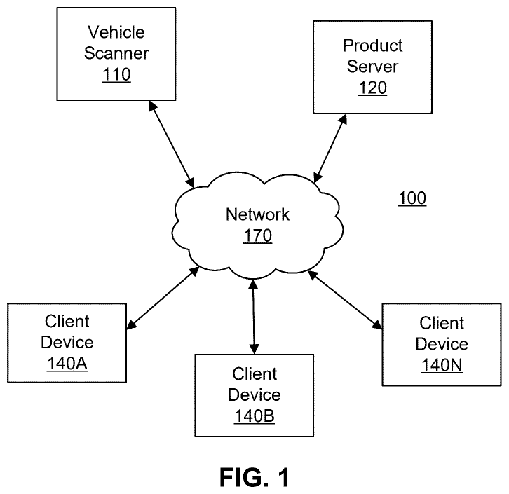

FIG. 1 illustrates one embodiment of a networked computing environment 100 suitable for providing vehicle-related products using vehicle health metrics. In the embodiment shown, the networked computing environment 100 includes a vehicle scanner 110, a product server 120, and one or more client devices 140, all connected via a network 170. In other embodiments, the networked computing environment 100 includes different or additional elements. In addition, the functions may be distributed among the elements in a different manner than described. For example, the vehicle scanner 110 may provide raw images of vehicles to the product server 120, with the product server 120 performing image analysis and calculating vehicle health metrics or the vehicle scanner 110 may perform some or all of the analysis and provide vehicle health metrics to the product server 120.

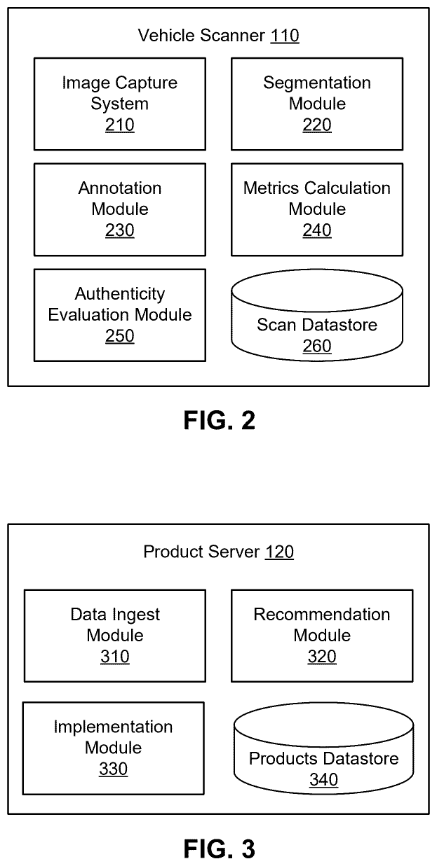

The vehicle scanner 110 captures images of a vehicle (e.g., a car, motorbike, recreational vehicle, or boat, etc.). The vehicle scanner 110 may be a fixed scanning system that the vehicle is placed within for a set of cameras to capture images of the vehicle from various perspectives. Alternatively, the vehicle scanner 110 may capture images using a handheld or otherwise mobile camera (such as the camera of a smartphone or camera of a drone that flies around the vehicle, etc.). In one embodiment, an operator records video of the vehicle using a handheld camera and is provided feedback on what additional perspectives of the vehicle to capture (e.g., with directions to capture video of the back or interior of the car, etc.). Regardless of how the images are captured, the vehicle scanner 110 calculates one or more metrics indicative of vehicle health from the images. Various embodiments of the vehicle scanner 110 are described in greater detail below, with reference to FIG. 2.

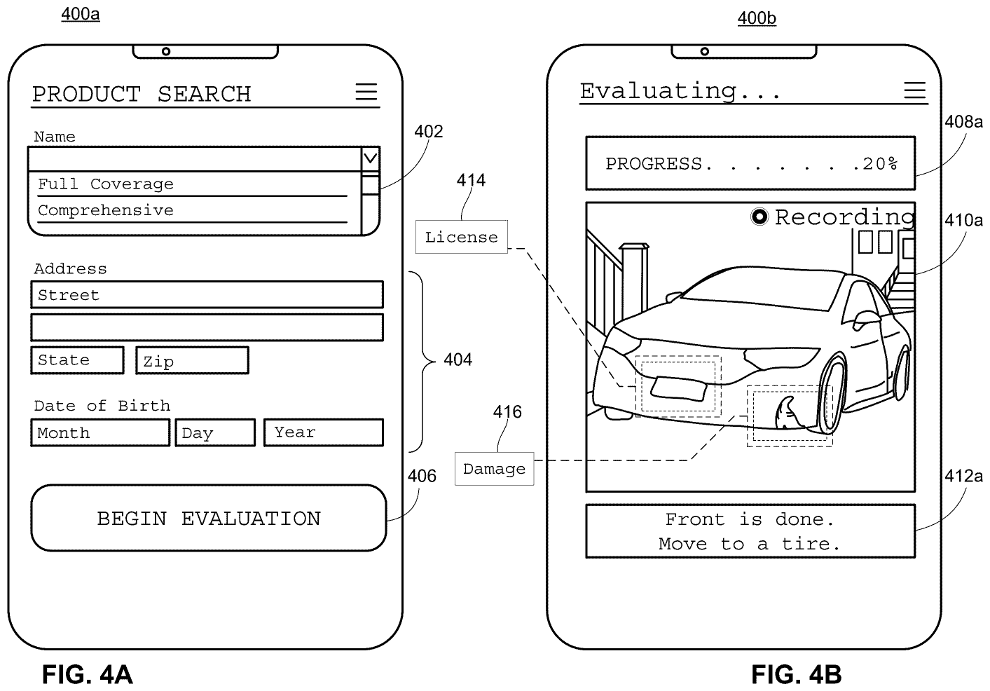

The product server 120 obtains one or more vehicle health metrics (e.g., from the vehicle scanner 110) and uses the vehicle health metrics to calculate parameters for a product associated with the vehicle. In one embodiment, the product is insurance for the vehicle. Broadly speaking, the health of the vehicle (e.g., whether the vehicle is in good or bad condition) is correlated with the risk of an insurance claim for the vehicle as well as the likely amount of such a claim. Thus, parameters of the insurance agreement, such as premium, maximum coverage amount, deductible, and optional coverage options, etc. can be more accurately tailored to the specific vehicle and owner using the vehicle health metrics than would be possible without such information. In another embodiment, the product is a tire for the vehicle. Product parameters for the tire can include a diameter, tread design, load index, speed rating, and other specifications associated with vehicle tires. A quote or other value figure for a product may also be a product parameter. Additional examples of product parameters for vehicle-related products include manufacturer name, a manufacturing year, a load index, a speed rating, a safety rating, a manufacturing material, a deductible, a coverage limit, a weight, a braking surface area, a temperature operating range, or any suitable characteristic of a product related to vehicles or driving. Various embodiments of the product server 120 are described in greater detail below, with reference to FIG. 3.

The client devices 140 are computing devices with which users associated with vehicles (e.g., owners) can interact with the products server 120 to obtain products for their vehicles. Although FIG. 1 includes three client devices 140A through 140N, the networked computing environment can include nay number of client devices 140. In one embodiment, the products server 120 provides a web interface that users access via a browser on a client device 140. The client device 140 may also serve as the vehicle scanner 110. For example, when requesting a product for a vehicle via a client device 140, the user may be directed to scan the vehicle using their client device, which then either calculates the vehicle health metrics and provides them to the product server 120 or provides the raw images to the product server for further analysis. In response, the product server 120 may provide one or more product parameters for the product. The product parameters can include a quote or other value figure for the product. The product parameter may be displayed in a user interface via which the user can accept the one or more product parameters and obtain the product having the one or more product parameters.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

FIG. 2 illustrates one embodiment of the vehicle scanner 110. In the embodiment shown, the vehicle scanner 110 includes an image capture system 210, a segmentation module 220, an annotation module 230, a metrics calculation module 240, an authenticity evaluation module 250, and a scan datastore 260. In other embodiments, the vehicle scanner 110 includes different or additional elements. In addition, the functions may be distributed among the elements in a different manner than described.

The image capture system 210 may include one or more cameras configured to capture images of a vehicle. In one embodiment, the user uses a handheld camera (e.g., on a smartphone) to capture images or video of the vehicle. While the description of the image capture system 210 may refer individually to image(s) or video(s) of a vehicle, the image capture system 210 may function similarly using either images or videos. In another embodiment, one or more cameras may be positioned around a vehicle to capture images of the vehicle remotely (i.e., without physical contact any of the cameras). The image capture system 210 may be communicatively coupled to one or more devices with cameras. The image capture system 210 may transmit an instruction to a device to cause the device to begin capturing images of a vehicle.

The image capture system 210 may provide feedback to the user to enable the user to efficiently capture images of the relevant parts of the vehicle. The image capture system 210 may receive a request for a vehicle-related product characterized by one or more product parameters (e.g., a tire having specifications including diameter or tread design). For a given product, the image capture system 210 may determine a list of parts of the vehicle for which images sufficient to analyze the condition of those parts should be captured. In one embodiment, the image capture system 210 may access a predefined list of vehicle parts associated with a vehicle-related product. In another embodiment, the image capture system 210 may access a history of previously captured images of a vehicle and previously identified parts of the vehicle and determine, based on this history, determine a list of vehicle parts needed to be captured to determine product parameters for a vehicle-related product. This may avoid unnecessary expense of computer processing or memory for vehicle parts previously identified that likely have not changed since the last time the image capture system 210 captured images of the car. Such vehicle parts may include the license plate, door(s), side view mirrors, or any vehicle part whose wear over time is relatively small. The image capture system 210 may maintain records of which vehicle parts were identified by the segmentation module 220 and when these parts were identified. These records may be used to determine the list of vehicle parts needed to be captured by the image capture system 210.

As video or images of the vehicle are captured, the image capture system may generate and cause prompts to be displayed (e.g., on a screen of the device with the camera). The prompts may include instructions of parts of the vehicle that the image capture system 210 still needs images of. For example, if the captured video includes sufficient images of the back wheels and front-right wheel of a car, a prompt may be generated or displayed instructing an automated camera setup or a user to capture video of the front-left wheel of the car.

The image capture system 210 may generate follow up prompts to instruct the re-capture of one or more images or video of the vehicle. The image capture system 210 may receive a list of vehicle parts identified by the segmentation module 220 from a first set of images or videos of a vehicle, compare the received list to a list of vehicle parts associated with a requested vehicle-related product, and determine whether the lists match one another. If a vehicle part has not been identified, the image capture system 210 may generate a follow up prompt instructing a user or an automated camera setup to recapture another image or video of the part that has not yet been identified. The image capture system 210 may generate a prompt specifying that the additional image or video be captured at an angle different from a previously captured angle of the part.

The image capture system 210 may continue capturing video of the vehicle until sufficient images have been captured of the portions of the vehicle identified as relevant for the product. The image capture system 210 may determine that sufficient images have been captured in response to receiving a list of vehicle parts identified by the segmentation module 220 and determining that the received list includes the portions of the vehicle identified as relevant for the product. The relevant portions may be determined by the image capture system based on product parameters necessary to recommend the product, where each product parameter is associated with a relevant portion of the vehicle. The image capture system 210 can determine whether images of the relevant portions of the vehicle have been taken, and if not, may cause a camera to continue capturing images of the vehicle. The image capture system 210 may additionally or alternatively generate a prompt instructing a user to capture an additional image of the vehicle.

In one embodiment, video capture may automatically end once the image capture system 210 determines that sufficient images have been captured. The image capture system 210 may determine that images of relevant portions of the vehicle have been taken and in response, cause a camera to stop capturing images of a vehicle. The image capture system 210 may generate a prompt notifying a user that they can stop capturing images of the vehicle. Alternatively, the user may determine when to end video capture based on feedback provided by the image capture system 210 (e.g., a percentage complete indicator may be displayed indicating a likelihood that the currently captured video will be sufficient to calculate the vehicle health metrics for the product). For example, the image capture system 210 may determine that images of three of four relevant portions of a vehicle have been captured to determine a recommended suspension upgrade. In particular, while the four relevant portions may be used to calculate a more accurate suspension upgrade recommendation, the recommendation can be determined with just the three captured. The image capture system 210 may generate a percentage indicator reflecting that 100% of the necessary parts have been captured in images. Additionally, the image capture system 210 may generate a prompt notifying that additional images can be captured for a more accurate recommendation.

The segmentation module 220 applies machine-learned classifiers to identify relevant parts of the vehicle within the images. For example, the segmentation module 220 may identify one or more of the: wheels, door, interior (e.g., the passenger compartment), windshield, VIN, year, make, model, trim level, or mileage etc. of the vehicle. The machine-learning models applied by the segmentation module 220 may be trained by using image data labeled with vehicle parts depicted in the corresponding images. The machine-learning models may be trained to detect anomalies in sets of images of a vehicle or a particular model of vehicle (e.g., detecting damage to paint as an anomaly among images of vehicle). The vehicle scanner 110 may train and re-train a machine-learning model for identifying parts of a vehicle. The vehicle scanner 110 may be communicatively coupled to a computing server whose processing resources are used to train and re-train the machine-learning model. The machine-learning model may be executed on the vehicle scanner 110 or a remote computing server.

The annotation module 230 adds metadata to the images based on parts of the vehicle identified by the segmentation module 220. In this context, adding metadata can refer to adding additional data to the image file or adding data to a separate metadata file associated with the image file. The metadata can include an identification of the part of the vehicle shown in an image (e.g., front-left tire, VIN number, rear bumper, etc.) and which pixels depict that part. The metadata can also include physical parameters for the depicted parts calculated from the images (e.g., a measure of tire tread wear, a measure of corrosion, a measure of damage, an alphanumeric representation of the VIN, etc.).

The annotation module 230 may apply image analysis to determine the metadata with which an image of a vehicle is labeled. The annotation module 230 may receive labels of identified parts from the segmentation module 220 and based on the labels, apply a corresponding image analysis to determine a vehicle health metric associated with a given labeled part. For example, an image of the front of a vehicle may be labeled to indicate that one or more headlights, front bumper, and a license plate are depicted. The annotation module 230 may receive the labels and determine, for different parts of the vehicle, to apply respective machine-learning models from a set of models associated with different parts of the vehicle. In another example, the annotation module 230 may receive labels of identified car parts and apply edge detection to an image labeled as depicting the front bumper of a vehicle, where the edge detection may indicate whether the bumper has been damaged. The resulting detection may be used by the metrics calculation module 240 to determine a vehicle health metric for the bumper. In yet another example, the annotation module may receive images labeled as depicting a tire of a vehicle and in response, apply perspective correction and three-dimensional image reconstruction to determine the dimensions of the tire. The dimensions of the tire may be used by the metrics calculation module 240 to calculate vehicle health metrics for the tire (e.g., the dimensions of an over or underinflated tire are different from the dimensions of an appropriately inflated tire).

The metrics calculation module 240 calculates one or more vehicle health metrics from the annotations. In one embodiment, the vehicle health metrics are a single number representing the overall health (condition) of the vehicle. In another embodiments, the metrics can include a measure of the health of each part of the vehicle identified by the segmentation module 220 (and potentially other aspects of the vehicle). For example, the metrics calculation module 240 may determine measures of one or more of: a condition of the front windshield glass, the tread on each tire, the condition of each wheel (e.g., whether there damage to the rims), dings and dents to doors or other body parts, mismatching paint color indicating potential repairs, damage to or absence of rear view mirrors, mismatch between tire brands, functional status of headlights, tail lights, and brake lights, or condition of a charge port or underbody of the battery pack (for electric vehicles), etc. Example mappings or methods for calculating a vehicle health metric are described with respect to Tables 1 and 2.

The metrics calculation module 240 may calculate one or more driver metrics. A driver metric may be a single number representing the safety record of the driver. A driver metric may be characteristics of the driver that may have a correlation to their safety record such as their age, number of years driving or date of driver's license issuance, type of license (e.g., commercial license), subtype of license (e.g., class A for tractor-trailers), whether the driver requires corrective lenses, or any suitable characteristic affecting their driving safety. The metrics calculation module 240 may obtain a driver metric from the user or from a database having records of the user's driving experience.

The authenticity evaluation module 250 determines whether images or video are authentically representing the vehicle for which a request for a vehicle-related product has been sought. A recommended product may be an inaccurate if a user is intentionally or accidentally providing inaccurate images of the vehicle. For example, a user requesting an estimate for an insurance premium may receive a value figure that is inaccurate if the user has purported their vehicle to be what is depicted by the images or video when the user's actual vehicle is not what is depicted. The user may provide some images of their actual vehicle's but provide an image of the odometer reading of another's vehicle. This information, when used to calculate an insurance premium, may result in a lower value figure than what is realistic. This behavior, whether intentional or accidental, may result in inaccurate estimates at best and an abuse of the system at worst.

The authenticity evaluation module 250 may verify whether a vehicle is present in frames of a video. The authenticity evaluation module 250 may apply computer vision to a given video frame of the video, where the computer vision enables object detection to determine whether a vehicle is not present in a frame. The authenticity evaluation module 250 may receive the results of the object detection as determined by a remote server that applies computer vision to the captured images of a vehicle. In response to determining that the vehicle is not present for a threshold number of video frames, the authenticity evaluation module 250 may flag the request for vehicle-related product initiated by the user as a low authenticity request. In response to determining that the vehicle is present for at least the threshold number of video frames, the authenticity evaluation module 250 may flag the request for the vehicle-related product as a high authenticity request.

The authenticity evaluation module 250 may determine a likelihood that a user-specified location for where the vehicle is stationed is authentic. The authenticity evaluation module 250 may receive location data corresponding to an area where a vehicle has been stationary for at least a threshold amount of time (e.g., eight hours). The location data may be determined using an on-vehicle sensor of the vehicle (e.g., a zip code of where the vehicle is parked). The authenticity evaluation module 250 may receive a user-specified area where the vehicle is stationary for at least the threshold amount of time. In response to determining that the location data does not match the user-specified area otherwise does not correspond to the user-specified area (e.g., the location data does not overlap with the user-specified area), the authenticity evaluation module 250 may flag the request initiated by the user for the vehicle-related product as a low authenticity request. In response to determining that the location data does match or otherwise corresponds to the user-specified area, the authenticity evaluation module 250 may flag the request as a high authenticity request.

The scans datastore 260 includes one or more non-transitory computer-readable media that store the information used by the vehicle scanner 110. The scans datastore 260 may include copies of the images captured by the image capture system 210 and the associated metadata generated by the annotations module 230. The scans datastore 260 may also include the model or models used to segment and label the images. Although the scans datastore 260 is shown as a single element that is local to the vehicle scanner 110, the scans datastore 260 may be split into multiple parts, some or all of which may be accessed remotely (e.g., via network 170).

FIG. 3 illustrates one embodiment of the product server 120. In the embodiment shown, the product server 120 includes a data ingest module 310, a recommendation module 320, an implementation module 330, and a product datastore 340. In other embodiments, the product server 120 includes different or additional elements. In addition, the functions may be distributed among the elements in a different manner than described.

The data ingest module 310 receives data regarding a vehicle. In one embodiment, the data includes one or more vehicle health metrics generated by the vehicle scanner 110. In another embodiment, the data includes images (e.g., a video) of the vehicle captured by the video scanner from which the data ingest module calculates one or more vehicle health metrics (e.g., using the techniques described previously with reference to the metrics calculation module 240). In some embodiments, the information received from the vehicle scanner 110 identifies the vehicle (e.g., with a VIN) and the data ingest module 310 retrieves additional information about the vehicle from a database. For example, the owner of the vehicle may opt in to providing an insurance provider with access to their vehicle data, enabling the data ingest module 310 to retrieve service data for the vehicle. Additionally or alternatively, the vehicle scanner 110 may retrieve information from an on-board computer of the vehicle (e.g., mileage, performance metrics, etc.) and provide that information to the data ingest module 310.

The recommendation module 320 selects a product associated with a vehicle to recommend to a user (e.g., owner) of that vehicle using the vehicle health metrics or driver metrics. Selecting the product may include calculating product parameters for the product from these metrics. In various embodiments, the recommendation module 320 uses the vehicle health metrics or driver metrics to calculate parameters for an insurance policy covering the vehicle, such as a premium, coverage amount, and deductible. The recommendation module 320 may use the vehicle health metrics or driver metrics to calculate product parameters for a new set of tires such as tire size, tread design, load index, and more.

In one such embodiment, the vehicle health metrics include an overall health score for the vehicle. The premium for the insurance policy may scale linearly with the health score. Alternatively, the premium may vary nonlinearly with health score, depending on other parameters. For example, a low health score (indicating the vehicle is in poor condition) may have less of an impact for young drivers who may be expected to typically have vehicles in poor condition and for whom their premiums are more strongly impacted by their age. Conversely, having an experienced driver having a vehicle with a low health score may be indicative of poor driving or maintenance habits and have a larger impact on the premium. Vehicle scans may determine condition factors such as wheel alignment to identify suspension problems, oil leaks that indicate a lack of maintenance, indicator lights on the dashboard (e.g., a check engine light being illuminated), brake pad wear, and the like.

The recommendation module 320 may calculate product parameters used to select a vehicle-related product for recommendation. The recommendation module 320 may assign weights to one or more vehicle health metrics or driver metrics and calculate a product parameter based on the weighted metrics. The recommendation module 320 may determine a likelihood that a given vehicle health metric or driver metric is associated with a particular product parameter and update, based on the determined likelihood, the weight associated with the metric. This may enable the recommendation module 320 to adapt to changes in the environment in which a user operates their vehicle. For example, a user moving from California to Minnesota would likely have a vehicle whose tires are more suited to the moderate climate of California than the harsher winters of Minnesota. The likelihood that the vehicle health metric of tire wear is associated with a product such as an insurance premium may be higher once the user moves to Minnesota. Additionally, determining probabilities that a driver metric is associated with a product parameter may enable the recommendation module 320 to account for and eliminate driving-related biases when determining a product recommendation. For example, if a user is a female driver in her early twenties with no record of accident since she began driving at the age of sixteen, the recommendation module 320 may determine a lower likelihood that her gender or age is associated with a product such as an insurance premium.

The implementation module 330 provides an offer for the recommended product to a client device 140 of the user. In the case of an insurance product, the implementation module 330 can send a product parameter (e.g., a value figure, a coverage type, a coverage duration, etc.) to insure the vehicle to the user's client device 140. Assuming, for example, that the user accepts the value figure (e.g., by selecting a confirm or buy button in a user interface on the client device 140), the implementation module 330 issues the insurance policy. This may include various steps, such as providing the details of the policy to a human operator for approval, causing a confirmation letter to be sent to the user, or automatically binding a user account of the user to the policy in a database (e.g., the products datastore 340).

The products datastore 340 includes one or more non-transitory computer-readable media that store data used by the product server 120. The data stored in the products datastore 340 can include a listing of potential products (e.g., different types of insurance and models for calculating policy parameters), issued policies (e.g., a user ID of the user holding the policy and the details of the policy), copies of the vehicle health metrics used to make product recommendations, and the like.

### Example User Interfaces

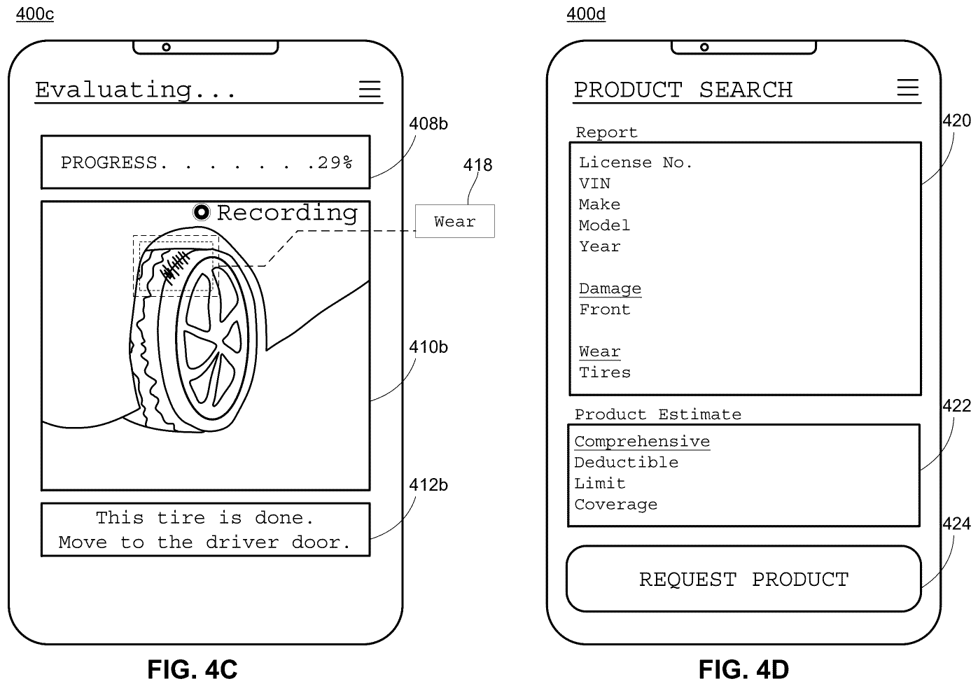

FIGS. 4A-4D depict graphical user interfaces (GUIs) for providing vehicle-related products, according to some embodiments. FIG. 4A depicts a GUI 400a for specifying search parameters for requesting a vehicle-related product. FIGS. 4B and 4C depict GUIs 400b and 400c, respectively, for capturing video(s) of a vehicle. FIG. 4D depicts a GUI 400d for recommending a vehicle-related product. The vehicle scanner 110, the product server 120, or a combination thereof may generate the GUIs or different portions of the GUIs and cause the generated GUIs to be displayed on a client device. For example, the product server 120 may generate the GUIs 400a and 400d while the vehicle scanner 110 may generate the GUIs 400b and 400c. The GUIs may include additional, fewer, or different graphical interface components (e.g., icons, buttons, text boxes, scrollbars, etc.). Components of the GUIs may be arranged differently than depicted. The GUIs may be displayed at a client device (e.g., the client devices 140A-N).

The GUI 400a includes a product type selection menu 402, biographical information text fields 404, and an evaluation button 406. The user's input to the menu 402 may be input to the recommendation module 320 for determining the vehicle-related product or the image capture system 210 for determining a list of portions of a vehicle for which images are needed to determine the vehicle-related product. For example, in response to the user selecting “tires” from the menu 402, the image capture system 210 may receive the user selection to determine that images of the tires of the vehicle are needed and from which angles to instruct a remote camera or the user to capture those images. The biographical information text fields 404 may include an address of where the vehicle is parked (e.g., an address of the user's residence), a date of birth of the driver, or although not depicted, any biographical information related to a vehicle-related product. The GUI 400a may adapt which biographical information text fields 404 are depicted in response to the user selecting different vehicle-related product types from the menu 402. For example, in response to selecting a full coverage insurance, the GUI 400a may update to display biographical text boxes for an address, date of birth, driver's license type, and other information related to determining a value figure for the full coverage insurance. If the user then changes their selection to a suspension upgrade, the GUI 400a may update to remove the displayed biographical text boxes for the address, date of birth, or other information not related to determining product parameters for the suspension upgrade. In response to the user selecting the evaluation button 406, the request for a product recommendation is sent to the product server 120 and the vehicle scanner 110 begins the process for capturing video of a vehicle.

The GUI 400b includes a progress bar 408a, a video feed window 410a, and a notification box 412a. The status of the progress bar 408a may be determined by the vehicle scanner 110 based on what vehicle parts have been identified by the segmentation module 220 and what vehicle parts need to be identified for recommending the vehicle-related product for which the user is searching. The progress bar 408a as shown in the GUI 400b indicates that the image capture process is at 20% completion (e.g., 20% of the vehicle parts needed have been identified or 20% of the necessary product parameters for determining a recommended vehicle-related product have been calculated). The vehicle scanner 110 may process the frames of the video feed to identify parts of the vehicle (e.g., a license plate 414) or identify metadata (e.g., damage 416) for labeling the frames of the video feed. The video feed window 410a reflects the video presently captured by the image capture system 210. In alternative embodiments of the GUI 400b, the video feed window 410a may depicts multiple video feeds (e.g., where the image capture system 210 is coupled to multiple cameras capturing the vehicle at various angles). The notification box 412a presents an instruction for capturing a different portion of the car, where the instruction may be determined by the image capture system 210 for display to the user. The notification box 412a indicates to the user that the front of the car has been captured (e.g., identified by the segmentation module 220) and to move to a tire to capture video of the tire.

The GUI 400c shows the progression from the GUI 400b of capturing the images of the vehicle. The user has moved over to a tire of the vehicle, where the video feed of the tire is reflected in the updated video feed window 410b. The vehicle scanner 110 may identify the tire in the video frames, where the updated progress bar 408b shows the increased progress from scanning 20% to 29% of the vehicle parts needed. The vehicle scanner 110 may determine the wear 418 of the tire, where the wear is a vehicle health metric for determining the recommended product. After determining that the tire has been identified or the vehicle health metric(s) of the identified tire has been calculated, the vehicle scanner 110 may generate an updated notification box 412b and the instructions displayed in the box (i.e., instructions that the tire has finished being scanned and to begin recording the driver door).

The GUI 400d may be displayed after the vehicle scanner 110 is finished capturing images of the vehicle or product parameters related to the requested product type are calculated. The GUI 400d includes a report text box 420, a product parameter estimate text box 422, and a product request button 424. The report text box 420 may include the results of the identified parts of the vehicle and vehicle health metrics determined by the vehicle scanner. For example, the report text box 420 displays the tires and the wear of the tires (e.g., an estimate of 30% wear compared to a new tire with 0% wear). The product parameter estimate text box 422 includes product parameters of the type of product requested and values of the product parameters calculated by the vehicle scanner 110. For example, the product parameters for comprehensive insurance may include a deductible, limit, and coverage amount. Although not depicted, the calculated values (e.g., in dollars) may be depicted in the product parameter estimate text box 422. A selection of the product request button 424 may cause the product server 120 to provide an offer for the recommended product having the product parameters listed in the text box 422.

### Example Methods

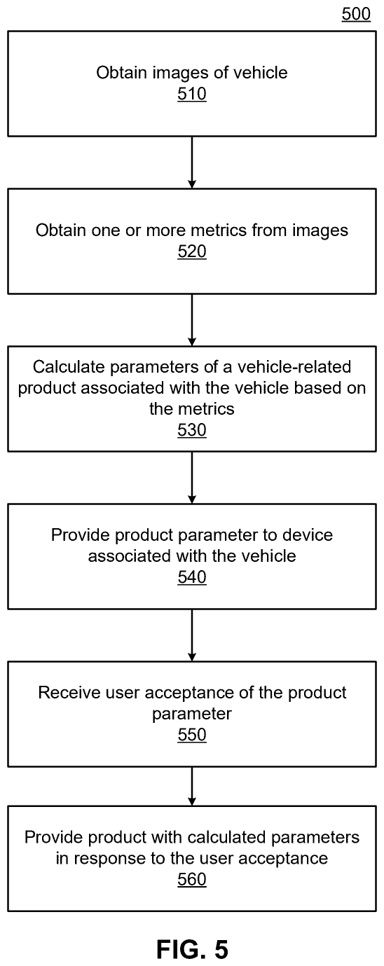

FIG. 5 illustrates a method 500 for recommending a product associated with a vehicle, according to one embodiment. The steps of FIG. 5 are illustrated from the perspective of various entities in the networked computing environment 100 performing the method 500. However, some or all of the steps may be performed by other entities or components. In addition, some embodiments may perform the steps in parallel, perform the steps in different orders, or perform different steps.

In the embodiment shown in FIG. 5, the method 500 begins by obtaining 510 images of the vehicle. For example, the vehicle scanner 110 may capture a video of the vehicle as described previously. The product server 120 obtains 520 one or more vehicle health metrics. The vehicle health metrics may be calculated from the captured images by the vehicle scanner 110, the product server 120, or a combination of both. Additionally or alternatively, vehicle health metrics may be obtained from an on-board computer of the vehicle, looked up in a database using an identifier of the vehicle (e.g., by querying a database using the vehicle's VIN), or any other available source of information about the vehicle. The product server 120 calculates 530 one or more parameters of the product using the vehicle health metrics. As described previously, the parameters may include a premium, coverage amount, or deductible for an insurance policy covering the vehicle.

The product server 120 provides 540 one of the product parameters. Providing 540 the product parameter may include sending an offer to a client device associated with a user (e.g., the owner) of the vehicle. The offer may include the product parameter (e.g., specifications for a new vehicle part, a value figure for a vehicle part or vehicle insurance, etc.). On receiving 550 acceptance of the product parameter, the product server 120 provides 560 the product having the parameters. For example, in the case of vehicle insurance, the product server 120 causes an insurance policy having the calculated parameters to be issued to the user.

In some embodiments, an initial product parameter is provided either without a vehicle scan or with a vehicle scan captured with a camera (e.g., by the vehicle owner). For example, an estimated value figure for collision insurance may be initially provided before a vehicle scan is performed. As part of the product provision process, the vehicle owner agrees to provide the product provider access to data about the vehicle. The vehicle owner may periodically provide updated vehicle scans. The updated vehicle scans, vehicle data accessible by the product provider (e.g., data from an on-board computer of the vehicle or from a vehicle database) may be used to modify the post of the product over time (e.g., premiums may be reduced if retrieved vehicle data indicates the vehicle is well maintained). For example, as part of an annual or semi-annual service, the vehicle may be scanned and data retrieved from the vehicle's on-board computer and the scan and retrieved data may be provided to the product provider for calculation of an updated premium and other parameters of the product (e.g., deductibles, exclusions, etc.).

### Example Product

This section describes a specific example of an insurance product that is priced based on the disclosed techniques. It should be appreciated that this example is provided by explain the disclosed concepts and should not be considered limiting on the scope of the disclosed principles. In this example embodiment, once the scanning process has been completed and data (images, video, vehicle driving and maintenance history, etc.) has been obtained, this data may be converted into an overall vehicle health condition score, which can then be used to derive an insurance premium discount or surcharge. The translation of internal and external data into a health score may be different based on each type of data (3rd party data, media, etc.). For example, an algorithm may be used to translate the frequency of a vehicle's maintenance checks on the impact of its overall health score, while a mapping table may be used to translate the condition of tires on the impact of its overall health score. Both examples are reflected in Table 1, below. Note that the example in Table 1 does not include all possible categories; it is merely to illustrate how different data may impact a vehicle's overall health score.

TABLE 1
An example of converting vehicle data to a vehicle health score for a specific vehicle

| Vehicle | | Type of | Translation | Impact on |
|---|---|---|---|---|
| Category | Assessment | Data | Used | Health Score |
| Windshield | Intact, no cracks, no chips | Media | Mapping | +3 |
| | | (photo) | file | |
| Tires | No material tread or wear | Media | Mapping | +2 |
| (surface) | | (video) | file | |
| Tires | Tire rotation performed every | Vehicle | Algorithm | +2 |
| (service) | 5,000 miles | history | | |
| Tires | Mismatched tire brands | Vehicle | Algorithm | −1 |
| (service) | | history | | |
| Lights | Headlights, tail lights functioning; | Media (photo | Mapping | −3 |
| | one brake light nonfunctioning | & video) | file | |
| Body (paint) | Minimal dents, matching paint color | Media | Mapping | +1 |
| | | (photo) | file | |
| Body | Material indentation on rear | Media | Mapping | −3 |
| (chassis) | passenger side, frame impacted | (video) | file | |
| Maintenance | Oil, battery, transmission, | Vehicle | Algorithm | +5 |
| History | filter checks performed per | history | | |
| | manufacturer's guide | | | |
| Scan | Driver has agreed to verified | Vehicle | N/A | +2 |
| Participation | scan participation program | history | | |
| Overall | | | | +8 |
| Impact: | | | | |

After all relevant data has been obtained and the overall impact on health score has been found, a rating factor table may be used to quantify the impact on an insured's premium. This rating factor table may be based on a model that reviews vehicle characteristics (examples seen in the “Category” column of Table 1) and quantifies their impacts on actual loss and loss adjustment expense costs (“LAE”). Loss and LAE costs are converted to premium by applying loss and LAE cost multiplication (“LCM”) factors, which represent insurer specific costs such as commission, other acquisition, general expenses, profit provision, taxes, etc. Typically, an insurance company that wishes to adopt these rating factors must apply to each state's respective department of insurance with support for these factors before they can be used in the market. Table 2 illustrates an example rating factor table that maps vehicle health scores to premium adjustments. Note that the example below does reflect actual approved rating factors; it is merely to illustrate an example of conversion of health scores into an insurance premium discount or surcharge.

TABLE 2
Example rating factor table mapping health scores to premium
adjustment for different types of insurance coverage.

| Health | Bodily | Property | | |
|---|---|---|---|---|
| Score | Injury | Damage | Comprehensive | Collision |
| 50 | 1.100 | 1.150 | 1.150 | 1.150 |
| 51 | 1.100 | 1.150 | 1.150 | 1.150 |
| 52 | 1.100 | 1.150 | 1.150 | 1.150 |
| 53 | 1.100 | 1.150 | 1.150 | 1.150 |
| 54 | 1.100 | 1.150 | 1.150 | 1.150 |
| 55 | 1.100 | 1.150 | 1.150 | 1.150 |
| 56 | 1.095 | 1.143 | 1.143 | 1.143 |
| 57 | 1.090 | 1.135 | 1.135 | 1.135 |
| 58 | 1.085 | 1.128 | 1.128 | 1.128 |
| 59 | 1.080 | 1.120 | 1.120 | 1.120 |
| 60 | 1.075 | 1.113 | 1.113 | 1.113 |
| 61 | 1.070 | 1.105 | 1.105 | 1.105 |
| 62 | 1.065 | 1.098 | 1.098 | 1.098 |
| 63 | 1.060 | 1.090 | 1.090 | 1.090 |
| 64 | 1.055 | 1.083 | 1.083 | 1.083 |
| 65 | 1.050 | 1.075 | 1.075 | 1.075 |
| 66 | 1.045 | 1.068 | 1.068 | 1.068 |
| 67 | 1.040 | 1.060 | 1.060 | 1.060 |
| 68 | 1.035 | 1.053 | 1.053 | 1.053 |
| 69 | 1.030 | 1.045 | 1.045 | 1.045 |
| 70 | 1.025 | 1.038 | 1.038 | 1.038 |
| 71 | 1.020 | 1.030 | 1.030 | 1.030 |
| 72 | 1.015 | 1.023 | 1.023 | 1.023 |
| 73 | 1.010 | 1.015 | 1.015 | 1.015 |
| 74 | 1.005 | 1.008 | 1.008 | 1.008 |
| 75 | 1.000 | 1.000 | 1.000 | 1.000 |
| 76 | 0.995 | 0.993 | 0.993 | 0.993 |
| 77 | 0.990 | 0.985 | 0.985 | 0.985 |
| 78 | 0.985 | 0.978 | 0.978 | 0.978 |
| 79 | 0.980 | 0.970 | 0.970 | 0.970 |
| 80 | 0.975 | 0.963 | 0.963 | 0.963 |
| 81 | 0.970 | 0.955 | 0.955 | 0.955 |
| 82 | 0.965 | 0.948 | 0.948 | 0.948 |
| 83 | 0.960 | 0.940 | 0.940 | 0.940 |
| 84 | 0.955 | 0.933 | 0.933 | 0.933 |
| 85 | 0.950 | 0.925 | 0.925 | 0.925 |
| 86 | 0.945 | 0.918 | 0.918 | 0.918 |
| 87 | 0.940 | 0.910 | 0.910 | 0.910 |
| 88 | 0.935 | 0.903 | 0.903 | 0.903 |
| 89 | 0.930 | 0.895 | 0.895 | 0.895 |
| 90 | 0.925 | 0.888 | 0.888 | 0.888 |
| 91 | 0.920 | 0.880 | 0.880 | 0.880 |
| 92 | 0.915 | 0.873 | 0.873 | 0.873 |
| 93 | 0.910 | 0.865 | 0.865 | 0.865 |
| 94 | 0.905 | 0.858 | 0.858 | 0.858 |
| 95 | 0.900 | 0.850 | 0.850 | 0.850 |
| 96 | 0.900 | 0.850 | 0.850 | 0.850 |
| 97 | 0.900 | 0.850 | 0.850 | 0.850 |
| 98 | 0.900 | 0.850 | 0.850 | 0.850 |
| 99 | 0.900 | 0.850 | 0.850 | 0.850 |
| 100 | 0.900 | 0.850 | 0.850 | 0.850 |

As the baseline, in this example, every vehicle starts with a neutral health score of 75, with increasing scores indicating a higher discount in premium and decreasing scores indicating a surcharge or increase in premium. Within Table 2, there is a +/−10% cap for the Bodily Injury (“BI”) coverage and +/−15% cap for Property Damage (“PD”), Comprehensive (“COMP”) and Collision (“COLL”) coverages. However, other caps may be used setting upper and lower limits for discount and surcharges. In the example from Table 1, the vehicle's overall health score is 83=(75+8).

Table 3 shows example typical premiums and an LCM factor for a 6-month policy.

| Assumptions | Value |
|---|---|
| BI Loss & LAE Cost | $80.24 |
| PD Loss & LAE Cost | $112.43 |
| COMP Loss & LAE Cost | $34.22 |
| COLL Loss & LAE Cost | $184.97 |
| Insurance Company LCM Factor | 24.26% |

Applying the discounts indicated in Table 2 for the vehicle illustrated in Table 1 to the policy of Table 3 illustrates how the disclosed techniques can provide significant savings for vehicles that are well maintained. In this example, the vehicle premium before health scan rating is given by (80.24+112.43+34.22+184.97)*(1+24.26%)=$511.78. After applying the health scan rating (with all other rating variables stay the same), the vehicle premium is: (80.24*0.96+112.43*0.94+34.22*0.94+184.97*0.94)*(1+24.26%)=$483.06, giving a saving of $28.72.

### Computing System Architecture

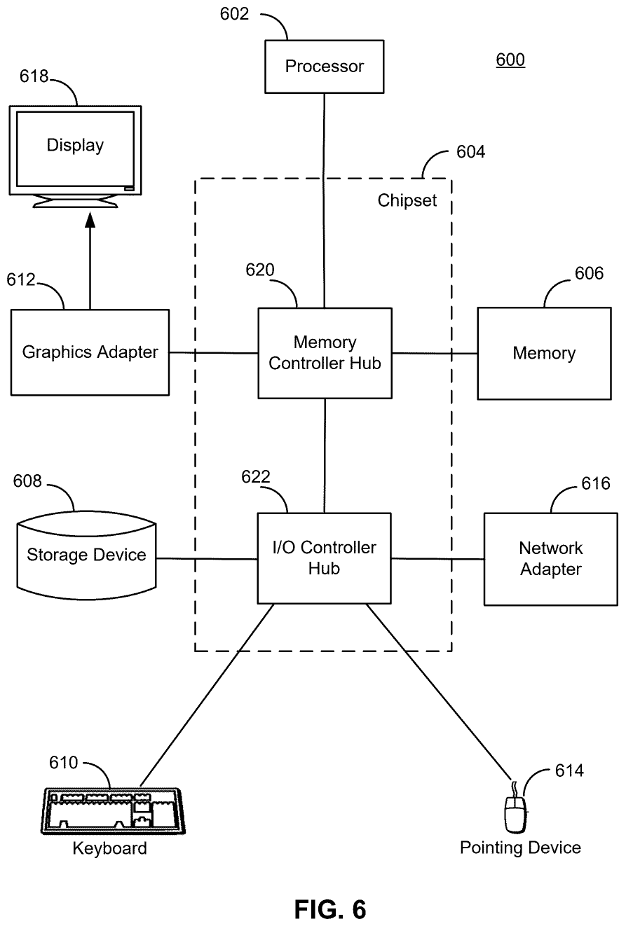

FIG. 6 is a block diagram of an example computer 600 suitable for use as a car scanner 110, product server 120, or client device 140. The example computer 600 includes at least one processor 602 coupled to a chipset 604. The chipset 604 includes a memory controller hub 620 and an input/output (I/O) controller hub 622. A memory 606 and a graphics adapter 612 are coupled to the memory controller hub 620, and a display 618 is coupled to the graphics adapter 612. A storage device 608, keyboard 610, pointing device 614, and network adapter 616 are coupled to the I/O controller hub 622. Other embodiments of the computer 600 have different architectures.

In the embodiment shown in FIG. 6, the storage device 608 is a non-transitory computer-readable storage medium such as a hard drive, compact disk read-only memory (CD-ROM), DVD, or a solid-state memory device. The memory 606 holds instructions and data used by the processor 602. The pointing device 614 is a mouse, track ball, touch-screen, or other type of pointing device, and may be used in combination with the keyboard 610 (which may be an on-screen keyboard) to input data into the computer system 600. The graphics adapter 612 displays images and other information on the display 618. The network adapter 616 couples the computer system 600 to one or more computer networks, such as network 170.

The types of computers used by the entities of FIGS. 1 through 3 can vary depending upon the embodiment and the processing power required by the entity. For example, the product server 120 might include multiple blade servers working together to provide the functionality described. Furthermore, the computers can lack some of the components described above, such as keyboards 610, graphics adapters 612, and displays 618.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by any claims that may issue.

What is claimed is:

1. A method of providing a vehicle-related product based on vehicle health metrics, the method comprising:
obtaining one or more vehicle health metrics, wherein the one or more vehicle health metrics were determined by:
capturing images of the vehicle;
applying one or more machine-learning models to identify parts of the vehicle in the images; and
generating the one or more vehicle health metrics from portions of the images corresponding to the identified parts of the vehicle;
calculating one or more product parameters of the vehicle-related product using the one or more vehicle health metrics; and
providing a product parameter of the one or more product parameters to a device associated with the vehicle.

2. The method of claim 1, further comprising:
receiving a request for the vehicle-related product, wherein the vehicle-related product is characterized by the one or more product parameters;
determining a list of vehicle parts based on the received request;
generating a first prompt to capture a first image of a part of the list of vehicle parts, wherein the first image is captured at a first angle;
comparing the identified parts of the vehicle to the list of vehicle parts; and
in response to determining that the part is not among the identified parts, generating a second prompt to capture a second image of the part of the list of vehicle parts at a second angle.

3. The method of claim 1, further comprising:
causing a device to begin capturing the images of the vehicle;
determining whether images of a list of portions of the vehicle have been obtained;
in response to determining that at least one of the images of the list of portions of the vehicle have not been obtained, generate a prompt to capture an additional image of the vehicle; and
in response to determining that the images of the list of portions of the vehicle have been obtained, cause the device to end capturing the images of the vehicle.

4. The method of claim 1, further comprising:
receiving an instruction accepting the product parameter; and
providing the vehicle-related product with the one or more product parameters to the device associated with the vehicle.

5. The method of claim 1, wherein the images of the vehicle are from a video of the vehicle, further comprising:
verifying whether the vehicle is present in each video frame of the video, wherein computer vision is applied to a given video frame to detect objects in the given video frame;
in response to determining that the vehicle is not present for a threshold number of video frames, flagging a request for the vehicle-related product as a low authenticity request; and
in response to determining that the vehicle is present for the threshold number of video frames, flagging the request for the vehicle-related product as a high authenticity request.

6. The method of claim 1, further comprising:
receiving location data corresponding to an area where the vehicle has been stationary for at least a threshold amount of time, wherein the location data is determined using an on-vehicle sensor of the vehicle;
receiving a user-specified area where the vehicle is stationary for at least the threshold amount of time;
determining whether the location data corresponds to the user-specified area;
in response to determining that the location data does not correspond to the user-specified area, flagging a request for the vehicle-related product as a low authenticity request; and
in response to determining that the location data corresponds to the user-specified area, flagging the request for the vehicle-related product as a high authenticity request.

7. The method of claim 1, wherein generating the one or more vehicle health metrics comprises:
accessing, based on an identified part of the vehicle depicted in an image, a type of product parameter whose calculated value is associated with a vehicle health metric of the identified part of the vehicle;
selecting, based on the type of product parameter, a machine-learning model from a set of machine-learning models trained to identify respective vehicle health metrics of a given vehicle; and
applying the machine-learning model to the image, wherein an output of the machine-learning model is a vehicle health metric of the one or more vehicle health metrics.

8. The method of claim 1, wherein calculating the one or more product parameters comprises:
determining a likelihood that a given vehicle health metric is associated with a particular product parameter of the one or more product parameters;
updating, based on the determined likelihood, a weight associated with the given vehicle health metric; and
calculating the particular product parameter based on the updated weight.

9. The method of claim 1, further comprising:
obtaining one or more driver metrics, wherein the one or more driver metrics include one or more of an age, a gender, a license type, a license subtype, a corrective lens requirement, a date of license issuance; and
wherein calculating the one or more product parameters of the vehicle-related product further uses the one or more driver metrics.

10. The method of claim 9, wherein the one or more driver metrics are determined by:
determining a likelihood that a given driver metric is associated with a particular product parameter of the one or more product parameters;
updating, based on the determined likelihood, a weight associated with the given driver metric; and
calculating the particular product parameter based on the updated weight.

11. The method of claim 1, wherein the parts of vehicle comprises a wheel, a door, an interior surface of a passenger compartment, a windshield, a license plate, a make of the vehicle, a model of the vehicle, or a trim level.

12. The method of claim 1, wherein the one or more product parameters comprises a manufacturer name, a manufacturing year, a load index, a speed rating, a safety rating, a manufacturing material, a value figure, a deductible, a coverage limit, a weight, a braking surface area, or a temperature operating range.

13. The method of claim 1, wherein the provided product parameter is a value figure.

14. A non-transitory computer-readable medium comprising instructions, the instructions, when executed by a computer system, causing the computer system to perform operations for providing a vehicle-related product based on vehicle health metrics including:
obtaining one or more vehicle health metrics, wherein the one or more vehicle health metrics were determined by:
capturing images of the vehicle;
applying one or more machine-learning models to identify parts of the vehicle in the images; and
generating the one or more vehicle health metrics from portions of the images corresponding to the identified parts of the vehicle;
calculating one or more product parameters of the vehicle-related product using the one or more vehicle health metrics; and
providing a product parameter of the one or more product parameters to a device associated with the vehicle.

15. The non-transitory computer-readable medium of claim 14, wherein the operations further comprise:
receiving a request for the vehicle-related product, wherein the vehicle-related product is characterized by the one or more product parameters;
determining a list of vehicle parts based on the received request;
generating a first prompt to capture a first image of a part of the list of vehicle parts, wherein the first image is captured at a first angle;
comparing the identified parts of the vehicle to the list of vehicle parts; and
in response to determining that the part is not among the identified parts, generating a second prompt to capture a second image of the part of the list of vehicle parts at a second angle.

16. The non-transitory computer-readable medium of claim 14, wherein the operations further comprise:
causing a device to begin capturing the images of the vehicle;
determining whether images of a list of portions of the vehicle have been obtained;
in response to determining that at least one of the images of the list of portions of the vehicle have not been obtained, generate a prompt to capture an additional image of the vehicle; and
in response to determining that the images of the list of portions of the vehicle have been obtained, cause the device to end capturing the images of the vehicle.

17. The non-transitory computer-readable medium of claim 14, wherein the operations further comprise:
receiving an instruction accepting the product parameter; and
providing the vehicle-related product with the one or more product parameters to the device associated with the vehicle.

18. The non-transitory computer-readable medium of claim 14, wherein the images of the vehicle are from a video of the vehicle, and wherein the operations further comprise:
verifying whether the vehicle is present in each video frame of the video, wherein computer vision is applied to a given video frame to detect objects in the given video frame;
in response to determining that the vehicle is not present for a threshold number of video frames, flagging a request for the vehicle-related product as a low authenticity request; and
in response to determining that the vehicle is present for the threshold number of video frames, flagging the request for the vehicle-related product as a high authenticity request.

19. The non-transitory computer-readable medium of claim 14, wherein the operations further comprise:
receiving location data corresponding to an area where the vehicle has been stationary for at least a threshold amount of time, wherein the location data is determined using an on-vehicle sensor of the vehicle;
receiving a user-specified area where the vehicle is stationary for at least the threshold amount of time;
determining whether the location data corresponds to the user-specified area;
in response to determining that the location data does not correspond to the user-specified area, flagging a request for the vehicle-related product as a low authenticity request; and
in response to determining that the location data corresponds to the user-specified area, flagging the request for the vehicle-related product as a high authenticity request.

20. The non-transitory computer-readable medium of claim 14, wherein generating the one or more vehicle health metrics comprises:
accessing, based on an identified part of the vehicle depicted in an image, a type of product parameter whose calculated value is associated with a vehicle health metric of the identified part of the vehicle;
selecting, based on the type of product parameter, a machine-learning model from a set of machine-learning models trained to identify respective vehicle health metrics of a given vehicle; and
applying the machine-learning model to the image, wherein an output of the machine-learning model is a vehicle health metric of the one or more vehicle health metrics.
